(19) United States
(12) Patent Application Publication
(10) Pub. No.: US 2005/0289081 A1
(43) Pub. Date: Dec. 29, 2005

(54) Computing system and method for secure sales transactions on a network

(76) Inventor: Manushantha Sporny, Blacksburg, VA (US)

Correspondence Address: DIEDERIKS & WHITELAW, PLC, #301, 12471 Dillingham Square, Woodbridge, VA, 22192, US

(21) Appl. No.: 11/189,926

(22) Filed: Jul. 27, 2005

Related U.S. Application Data
(63) Continuation-in-part of application No. 10/709,819, filed on May 31, 2004.
(60) Provisional application No. 60/481,016, filed on Jun. 24, 2003.

(51) Int. Cl. G06Q 99/00

(52) U.S. Cl. 705/64; 705/52

(57) ABSTRACT

A Secure File Distribution Network (SFDN) method and computer system allows copyrighted digital data files to be sold securely by independent sales parties and ensures that all authors and distributors of the work are paid all royalties and fees owed to them, regardless of who is selling the file. A verification authority tracks all buyers, sellers and digital data files being traded on the SFDN, matches buyers with sellers, and provides a digital data file search service for users of the system. Once a digital data file is located in the desired media format, and at an attractive price, a buyer and seller can negotiate a secure transaction. Once the transaction is completed using the SFDN, the verification authority distributes payments to the seller and all payees due a royalty payment. Thus the SFDN provides content authors security in earning a living while not impinging on consumer's fair use rights.

### CROSS REFERENCE TO RELATED APPLICATIONS

This application is a continuation-in-part of U.S. application Ser. No. 10/709,819, filed May 31, 2004, that claims the benefit of U.S. Provisional Application Ser. No. 60/481,016, filed Jun. 24, 2003, both of which are hereby incorporated by reference.

### BACKGROUND OF INVENTION

Digital media e-commerce is a fairly new economic medium and is currently threatened by software piracy. Recent legislative changes, such as the Digital Millennium Copyright Act of 1998, the extension of copyright protection, and the increasing support for digital rights management, all underscore the importance of digital media sales in our future economy. The greatest obstacle to the digital media industry is the development of a secure, online, primary and secondary marketplace that protects the creator's intellectual property. Currently, making exact copies of any digital media is relatively effortless and people often pay no attention to appropriate royalty reimbursement.

It is estimated that the U.S. film industry loses more than three billion dollars in revenue per year due to piracy, while the U.S. music industry loses more than four billion dollars annually. Clearly, piracy is a significant concern to content producers. The introduction of digital media and high-speed networks has aided the spread of piracy from an underground culture to a pop-culture, with an average of three million people illegally trading copyrighted works at any given time. This proliferation of digital music piracy resulted in damages in excess of one billion dollars during 2002.

Since the creation of file-sharing networks such as Napster™, Kazaa™, Morpheus™, Gnutella, and LimeWire™, digital content creators have been fighting an increasingly difficult battle against digital piracy. The Recording Industry Association of America (RIAA) and the Motion Picture Association of America (MPAA) represent content creators who are concerned about the protection of their creative works, while various corporations such as Napster, Inc. and StreamCast Networks, Inc. represent file-sharing systems that enable customers to share various forms of media. Both sides are desperately struggling for their respective positions with no meaningful solution to the piracy problem in sight. Meanwhile, consumers are harmed by recent legislation passed in response to pervasive digital piracy. Increasingly restrictive fair-use rights, digital rights management initiatives, and trusted computing initiatives restrict a consumer's option to truly utilize all the privileges of ownership to a purchased digital device or work.

Most parties involved in digital media and the entertainment industries suggest that the flashpoint for digital piracy was the invention of the Motion Pictures Experts Group 1 Layer 3 (MP3) file format and the Napster file-sharing network. In the early 1990s, when the Internet was just beginning its meteoric rise into mainstream culture, transferring media files from computer to computer was cost prohibitive. Streaming media compression formats for multi-media had not reached widespread use; most media files were too large for the delivery medium. Equally important was the quality of most compression formats, which were not as robust as formats available today.

The MP3 file format was patented in 1989 by Fraunhofer-Gesellschaft and Thompson Multimedia. It did not gain widespread acceptance as a streaming sound file format until 1997. At the same time, compact disks (CDs) were becoming the most popular sales medium for music, providing crystal clear playback in a format that would not degrade over time. These digital audio files were often quite large (e.g., a 5 minute song could require more than 40 megabytes), far too large to download in a reasonable amount of time even using today's standards. The subsequent MP3 format allowed a consumer to encode the 40-megabyte CD file into an MP3 file, which might be only 5 megabytes in size. The MP3 file could then be decoded using a media player, producing a sound almost acoustically indistinguishable from the original. It was this breakthrough that made audio transfer and piracy feasible using low-bandwidth Internet connections.

Many computer-savvy music listeners started digitizing their entire music collections, which offered the convenience of accessing their entire music collection without having to search through a stack of plastic CDs. Some listeners started to illegally trade their music over the Internet. However, the digital music piracy problem became epidemic when the first generation of file sharing applications started operating in late 1997. The most notorious of these was Napster, which, at its height, had over 70 million users and facilitated more than 3 billion file downloads per month, most of which have been alleged as pirated material. So, what made Napster such an effective application? The core benefit of any file-sharing network is that it enables relatively fast searches across the contents on the sharing network. A file-sharing network usually includes millions of computers with a combined file pool of billions of files. The summed storage space and bandwidth availability of the combined systems are far greater than most large corporations could ever support. A user of the Napster system could search for a song encoded in the MP3 format and, within minutes, download it anonymously without paying a fee for the service or royalties for the downloaded file. Users could share their entire music collection and anonymously trade with others, resulting in the single largest, publicly-accessible database for music ever created.

The fruits of this new file-sharing network have been countless lawsuits over intellectual property rights, freedom of expression, digital piracy and consumer content ownership. These battles continue today, where the second generation of file-sharing networks, such as Kazaa™, Grokster™, Morpheus™ and others, have subsequently failed due to mass piracy on their networks, resulting in litigation by the RIAA and the MPAA. The digital content industries have chosen to solve the problem in several ways: litigation threats and action, consumer copyright education, digital guerilla warfare, intellectual property (IP) protection legislation, digital rights management, and more-secure computing initiatives. While some of these initiatives are needed and on target, the industry's main focus in curbing digital piracy may be misguided, in that some of these initiatives have done more harm than good. Consumers have become increasingly concerned with the strategies of both the RIAA and MPAA, with some consumers reacting quite negatively to the infringement of their fair-use rights. The technology protection that content companies (i.e. those who produce digital media) are seeking is not likely to stop piracy or to be accepted by mainstream consumers. In fact there has never been a digital rights management system that could not be bypassed. Piracy on this scale is a social problem just as much as it is a technological and financial problem. Thus any solution must be approached from social as well as financial and technological perspectives.

Based on the above, there exists a need in the art for a network that simultaneously protects and remunerates intellectual property owners and acknowledges the rights of producers to be fairly compensated in a primary market, yet allows consumers the right to benefit from sales in a secondary market.

### SUMMARY OF INVENTION

The present invention is directed to a method and computer system that allows digital data files to be sold securely by independent sales parties. The system, referred to herein as the Secure File Distribution Network (SFDN), ensures that all authors and distributors (or payees) of copyrighted merchantable works associated with the digital data files are paid all royalties and fees owed to them, regardless of who is selling the merchantable work and without damaging fair-use rights. There are four parties that participate in any transaction in the system: a verification authority, a seller, a buyer and a payee. The verification authority keeps track of all buyers, sellers, payees, and digital data files being traded on the file sales network. A digital data file is any merchantable digital work that is being sold on the file sales network. The verification authority is responsible for matching buyers with sellers and providing a search service for users of the system so that digital data files can be found easily. Once a merchantable work is located in the desired media format, and at an attractive price point, a buyer and seller can negotiate a secure transaction. Once the secure transaction is completed (i.e., a buyer has the digital media purchased), the verification authority will distribute payments to the seller and all payees (or copyright owners) involved in a particular work.

### BRIEF DESCRIPTION OF THE DRAWINGS

FIG. 1 is an illustration of some of the basic components of the secure file distribution network of the present invention;

FIG. 2 is a flow chart showing the preferred steps for registering a seller with the secure file distribution network of the present invention;

FIG. 3 is a flow chart showing the preferred steps for registering a payee with the secure file distribution network of the present invention;

FIG. 4 is a flow chart showing the preferred steps for registering a buyer with the secure file distribution network of the present invention;

FIG. 5 is a flow chart showing the preferred steps for registering a merchantable work object with the secure file distribution network of the present invention;

FIG. 6 is a flow chart showing the preferred steps for registering a plurality of merchantable work objects or catalog objects with the secure file distribution network of the present invention;

FIGS. 7A and 7B present a flow chart of a process for searching and purchasing a digital data file utilizing the secure file distribution network of the present invention; and

FIG. 8 is a flow chart showing an overview of the preferred funds distribution process of the present invention.

### DETAILED DESCRIPTION OF THE PREFERRED EMBODIMENT

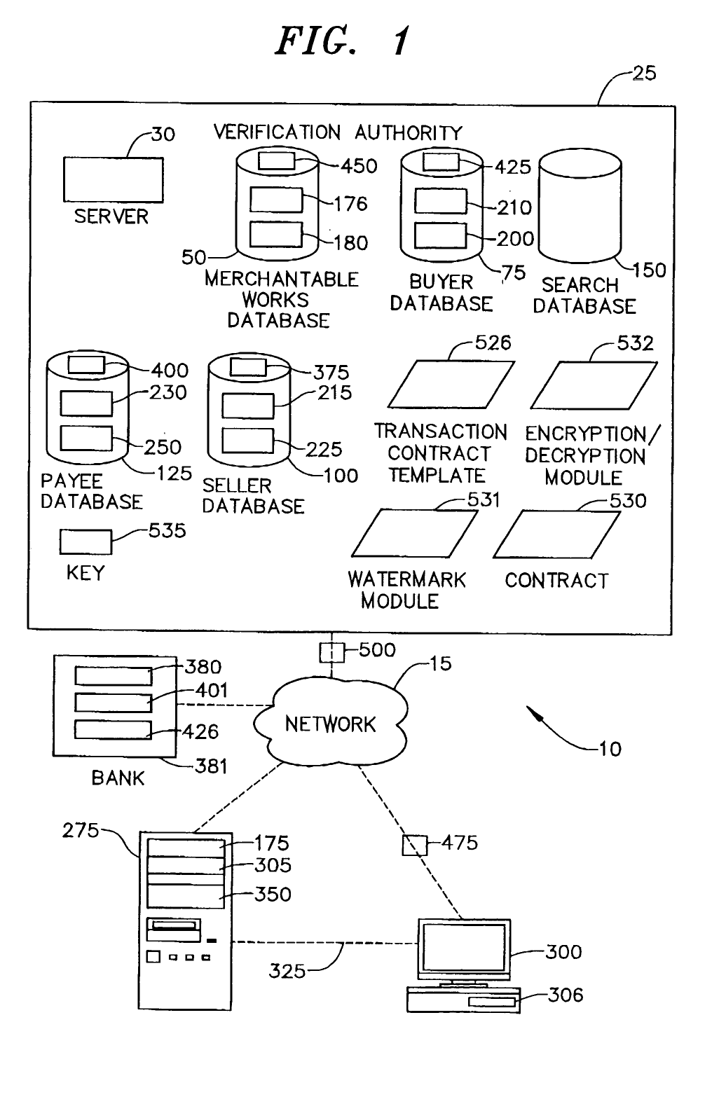

FIG. 1 depicts some of the basic components of a computer system or secure file distribution network (SFDN) 10 of the present invention. The SFDN 10 is essentially a secure peer-to-peer transaction system for online buying and selling of digital media such as audio files, video files, computer programs, electronic books, visual images (pictures), and the like. SFDN 10 preferably utilizes a plurality of data processors or servers 30 and a communications network 15, such as the Internet, to communicate with users of the system. A verification authority 25 at the core of SFDN 10 verifies each transaction and ensures that the correct parties involved get their agreed upon royalty and fee payments. Verification authority 25 comprises a number of databases including a merchantable works database 50, a buyer database 75, a seller database 100, a payee database 125 and a search database 150. Verification authority 25 may reside on one or multiple servers 30 connected to a communications network 15 as a single or distributed computer system.

The merchantable works database 50 is used to store information about each merchantable work and any associated digital data file(s) 175 that is available for purchase through SFDN 10. Such information is stored in the form of a merchantable work object 180. In order to make searches of merchantable works database 50 more efficient, an index 176 may be provided. Digital data file 175 may be any digital media file capable of being transferred via a communications network. In a preferred embodiment, digital data file 175 is a digital audio file and the merchantable work object 180 associated with digital data file 175 contains merchantable work information such as the author/artist, date of creation, royalty scheme, royalty payees, allowable file formats, allowable distributors, and the like. All or some of the information contained in merchantable work object 180 is provided by an author or copyright holder of a creative work associated with digital data file 175.

Buyer database 75 stores information regarding buyer accounts 200 and has an index 210. Each buyer account 200 includes a buyer's name, identification (ID), and account balance. Preferably, each buyer account 200 also includes other items such as transaction history, trustworthiness rating 212, buying preferences, and contact information.

Seller database 100 stores information regarding seller accounts 225 and has an index 215. Each seller account 225 includes a seller's name, ID, account balance, and real-world bank account number along with other banking related information. Preferably, seller database 100 also includes other items such as transaction history, trustworthiness rating 227, selling preferences, seller rating and contact information.

Payee database 125 stores information regarding payee accounts 250 and has an index 230. Each payee account 250 includes a payee's name, ID, and account balance. Preferably, each payee account 250 also includes additional information such as transaction history, banking related information, and contact information. Artists, producers, and other such entities (payees) of creative work associated with a digital data file 175, but not involved in purchasing transactions on SFDN 10, are each assigned a payee account 250 on system 10. These payees include persons whom have a legal claim to royalties from the sale of copyrighted information associated with digital data file 175.

Search database 150 associates a particularly digital data file 175 with a particular seller and allows a user of the SFDN 10 to search for the location of a particular digital data file 175 quickly and precisely. Information other than just the title of a digital data file 175 is preferably incorporated into search database 150 to improve search performance and precision. For example, information and indexes such as most popular works, independent works, media type, royalty scheme, media genre, cost and other search criteria are preferably incorporated into merchantable work object 180. While shown as having both a merchantable works database 50 and a search database 150, system 10 could easily operate with these two databases merged into a single database. For example, merchantable works database 50 could contain all of information necessary to conduct a search.

As illustrated in FIG. 1, other components of SFDN 10 include a seller data processor 275 and a buyer data processor 300. Seller data processor 275 is responsible for providing a set of digital data files 175 that may be purchased through verification authority 25 by a buyer utilizing a buyer data processor 300. A seller application 305 and a buyer application 306 are available to a user through SFDN 10. Seller application 305 and buyer application 306 allow buyers and sellers to interact with SFDN 10 and are preferably in the form of downloadable software available for download from SFDN 10 via a web site. A plurality of merchantable work objects 180 associated with respective digital data files 175 for sale are registered into SFDN 10 by a seller utilizing seller data processor 275 and seller application 305, and are indexed (as index 176) in merchantable works database 50.

Information regarding the creative works associated with the digital data files 175 for sale is entered in search database 150. A buyer, utilizing buyer data processor 300 and buyer application 306 can then perform a search for a particular creative work and any associated digital data file(s) 175 through verification authority 25. The verification authority utilizes search database 150 and merchantable works database 50 to generate a list of seller data processors 275 that are hosting the desired digital data file(s) 175 for purchase. Optionally, a peer-to-peer search can be conducted by users of the SFDN 10 contacting one another to request a particular creative work and its associated digital data file(s) 175. It should be understood that more than one seller data processor 275 can contain the same or a similar digital data file 175 associated with a particular creative work. Once a desired digital data file 175 is located, a transaction may then occur over a peer-to-peer connection 325, a process that is discussed below.

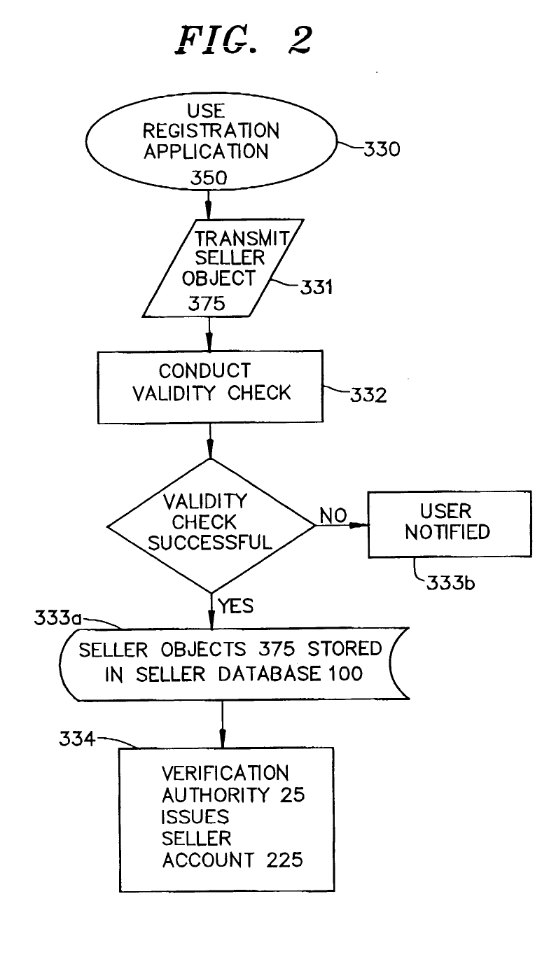

The process by which buyers, sellers and payees register with SFDN 10 will now be described with reference to FIGS. 1-5. A user who wishes to sell a digital data file 175 using SFDN 10 will register with verification authority 25 and receive a seller account 225. Initially, as indicated in steps 330 and 331 of FIG. 2, a user utilizes a registration application 350 to contact verification authority 25 and transmits a message containing a seller object 375. Registration application 350 is preferably in the form of software downloadable from SFDN 10. A seller object 375 comprises information relating to a real-world entity such as a person or legal entity that wishes to sell a digital data file 175 on the SFDN 10. Seller object 375 preferably contains at least the following seller description items: username, password, entity name, and e-mail address. Seller object 375 also preferably contains information regarding a verified financial account 380 in a bank 381 which will be utilized at a later time should a user wish to transfer their funds out of seller account 225. After seller object 375 has been transmitted to verification authority 25, the contents are checked for validity by an internal (automatically processed) or external entity (processed by an authoritative entity working on behalf of the verification authority 25) in step 332. Although it is contemplated that any information within seller object 375 can be verified, preferably verification authority 25 verifies that the user's financial account 380 (i.e. credit card) information is valid, that the user's address is a real address, and that the address listed with the financial account information matches the user's address. Additionally, official government identification could be utilized to verify an individual's information. If the validity check is a success, seller object 375 becomes inserted into seller database 100 at step 333a. If the validity check is unsuccessful as indicated at step 333b, the user is notified and the seller object 375 is not stored in seller database 100. If valid, seller object 375 information may then be used by the authorized seller to distribute and charge for downloading digital data file 175. At this point, verification authority 25 provides the user with seller account 225, as indicated at step 334.

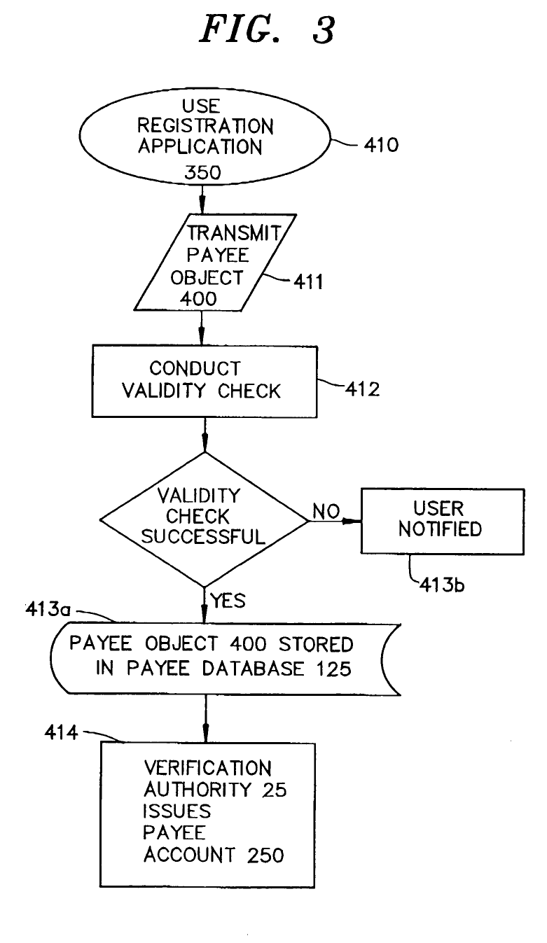

The process for registering a payee object 400 with verification authority 25 is very similar to registering a seller object 375. Referring to steps 410 and 411 in FIG. 3, a user, utilizing a registration application 350, contacts verification authority 25 and transmits a message containing a payee object 400 to be stored in payee database 125. A payee object 400 includes information relating to a real-world entity such as a person or legal entity that should be reimbursed for digital data files 175 sold on SFDN 10. Preferably a payee object 400 contains at least the following payee description items: username, password, entity name and e-mail address. The payee object 400 also preferably contains information regarding a verified financial account 401 which will be utilized at a later time should a payee wish to transfer their funds out of payee account 250. After payee object 400 has been transmitted to verification authority 25, the contents are checked for validity by an internal (automatically processed) or external entity (processed by an authoritative entity working on behalf of verification authority 25) as in step 412. Although it is contemplated that any information within payee object 400 can be verified, preferably verification authority 25 verifies that the user's financial account 401 (i.e. credit card) information is valid, that the user's address is a real address, and that the address listed with the financial account information matches the user's address. Additionally, official government identification could be utilized to verify an individuals information. If the validity check is a success, the payee object 400 becomes inserted into payee database 125 in step 413a. The payee object information may then be used to determine royalty amounts and payees for each particular digital data file 175 sold through SFDN 10. At this point, verification authority 25 provides the user with payee account 250, as indicated at step 414. If the validity check is not successful, the user will be notified at step 413b.

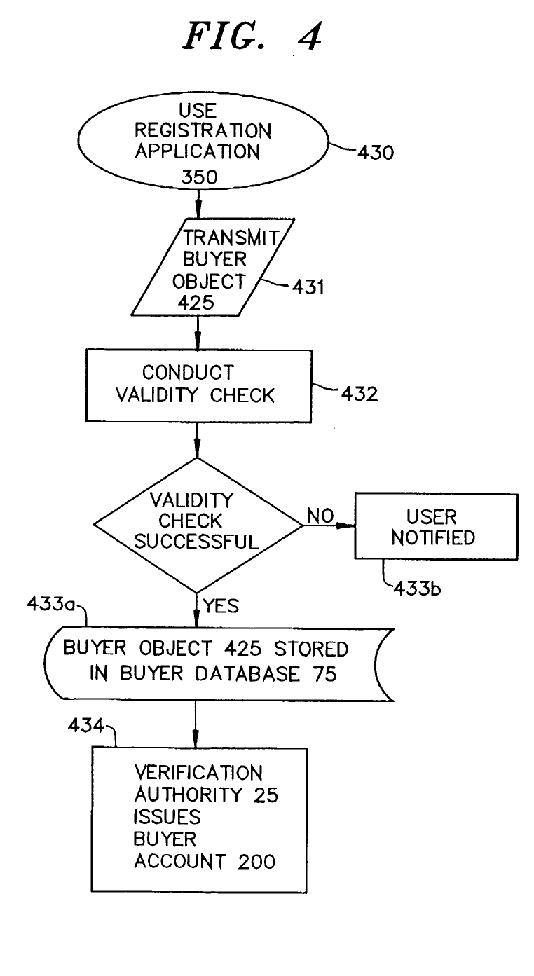

FIG. 4 illustrates the steps involved in registering a buyer object 425 with verification authority 25. This process is similar in nature to registering a seller object 375 or payee object 400. Referring to steps 430 and 431, a user, utilizing registration application 350, contacts verification authority 25 and transmits a message containing a buyer object 425 to be stored in buyer database 75. Buyer object 425 includes information relating to a real-world entity such as a person or legal entity that wishes to buy digital media on the SFDN 10. Preferably, buyer object 425 also contains at least the following buyer description items; username, password, entity name and e-mail address. The buyer object 425 also preferably contains information regarding verified financial account 426 (see FIG. 1). After buyer object 425 has been transmitted to verification authority 25, the contents are checked for validity by an internal (automatically processed) or external entity (processed by an authoritative entity working on behalf of verification authority 25) at step 432. Although it is contemplated that any information within buyer object 425 can be verified, preferably verification authority 25 verifies that the user's financial account 426 (e.g. credit card) information is valid, that the user's address is a real address, and that the address listed with the financial account information matches the user's address. Additionally, official government identification could be utilized to verify an individual's information. If the validity check is a success, buyer object 425 becomes inserted into buyer database 75 at step 433a. At this point, verification authority 25 provides the user with buyer account 200 as indicated at step 434. The user (buyer) may then be charged via bank card, credit card or other form of funds transfer and the user's buyer account 200 credited to enable the user to purchase digital data files 175 using SFDN 10. If the validity check is not successful, the user is notified at step 433b.

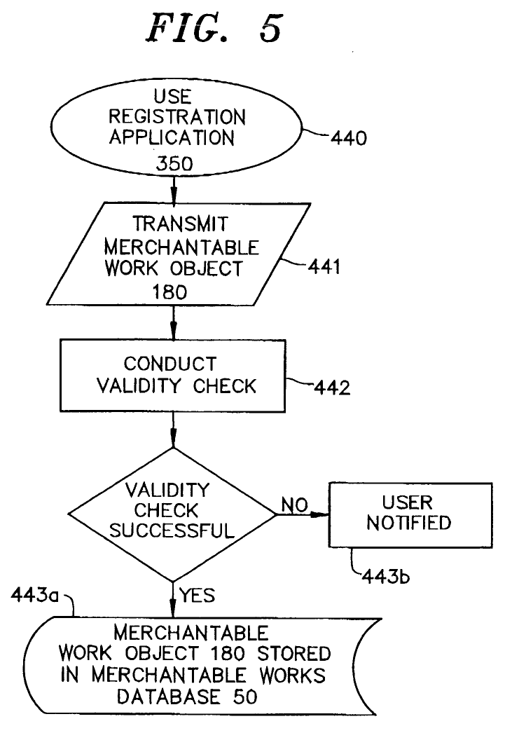

As depicted in steps 440 and 441 in FIG. 5, a registered user who wishes to sell a digital data file 175 on SFDN 10 contacts verification authority 25 and transmits a message containing a merchantable work object 180 (associated with digital data file 175) to be stored in merchantable works database 50. As previously mentioned, digital data file 175 has an associated merchantable work object 180 that includes a general media file description and optional media specific information. For example, a merchantable work object 180 of a song preferably contains at least the following general media file description items: description, copyright owner, list of royalty payees, and list of allowable distributors. The music specific information preferably contains at least the following music media file description items: artist, album, song title, and allowable file formats. Verification authority 25, upon receiving the message from the user, processes and checks the message for validity at step 442, and if the request is a valid one, inserts the merchantable work object 180 into merchantable works database 50 at step 443a. Additionally, relevant information regarding the work is placed in the search database 150. The process of deciding if a message is valid may be internally (automatically processed) or externally processed (processed by an authoritative human being working on behalf of verification authority 25). Preferably, verification authority 25 reviews information submitted to make sure that the merchantable work object 180 has not already been registered by the user, that the user registering the merchantable work object 180 has the right to do so and that the merchantable work object 180 includes descriptive information and payee information. If the validity check is not successful, the user is notified at step 443b.

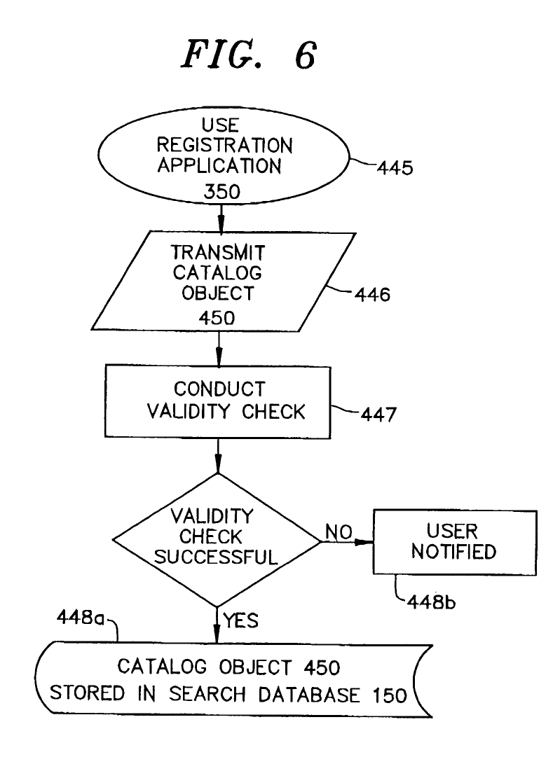

FIG. 6 is an overview of the process by which a seller registers a plurality of merchantable work objects 175 with SFDN 10. Preferably, once a seller has registered themselves with verification authority 25 (as depicted in FIG. 2), the seller provides SFDN 10 with a list of merchantable work objects 180 associated with digital data files 175 the seller wishes to offer for sale. As depicted in steps 445 and 446, a seller contacts verification authority 25 and transmits a message containing a seller catalog object 450 to be stored in search database 150. A seller catalog object 450 includes information relating to a subset of, or the whole file catalog of, merchantable works that a seller, through seller data processor 275, is offering for purchase. Seller catalog object 450 is essentially a group of merchantable work objects 180 and preferably includes at least a seller identification number and a list of files, where each file must have at least a merchantable work identifier and may optionally have other information such as, but not limited to: transaction fee, file type and file size. After seller catalog object 450 has been transmitted to verification authority 25, the contents are checked for validity by an internal (automatically processed) or external entity (processed by an authoritative entity working on behalf of verification authority 25) as in step 447. Preferably, verification authority 25 reviews submitted information to verify that the digital data file 180 listed for sale in seller catalog object 450 is authorized for sale on the network and that the digital data file 180 for sale is in an allowable sale format (i.e. that the file format is allowed by the artist/author). If the validity check is a success, seller catalog object 450 is placed in merchantable works database 50 and relevant portions of the catalog object 450 are merged into the network-wide search information in search database 150 at step 448a. If the validity check is not successful, the seller is notified at step 448b.

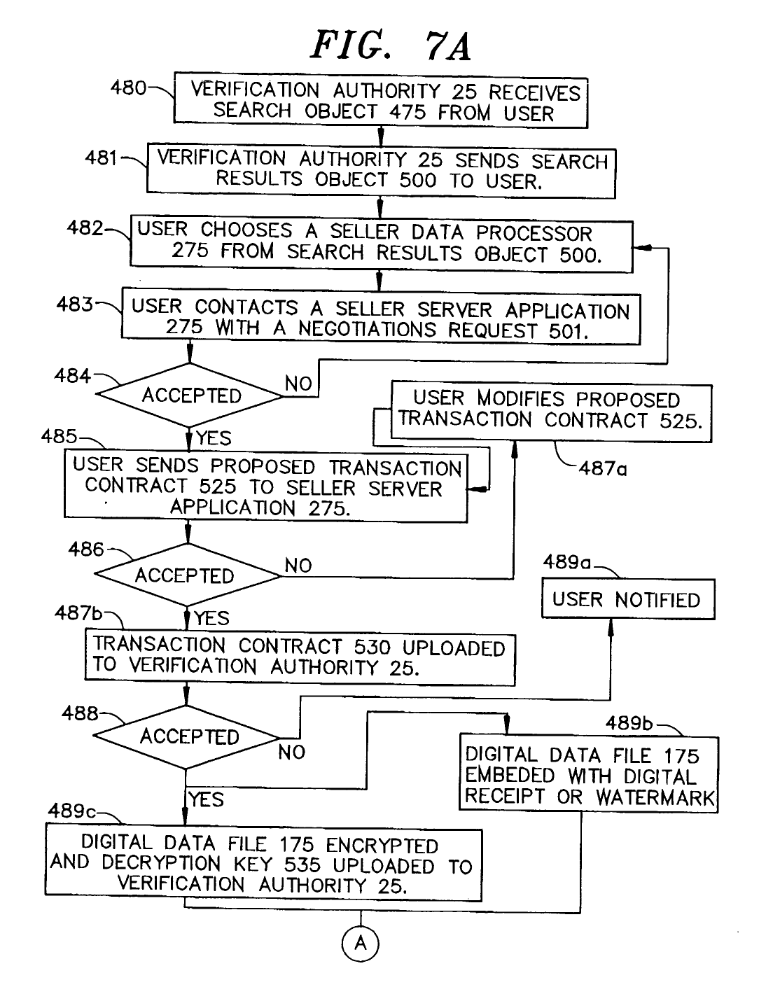

FIGS. 7A and 7B outline the process by which a user searches for and purchases a particular digital data file 175 using SFDN 10. Initially, as indicated by step 480 in FIG. 7A, a user transmits a message to verification authority 25 containing a search object 475. Search object 475 contains at least one merchantable work identifier, such as the title of a song. Verification authority 25 provides a simple method of searching for merchantable work identifiers based on any information that is contained in the merchantable work identifier or in merchantable work object 180. For example, a user can utilize buyer data processor 300 to access verification authority 25 via a web page and perform a search for a particular artist of a song.

At step 481, verification authority 25 sends the user a search results object 500 comprising a list of any merchantable work objects 180 that match the search criteria. More specifically, search results object 500 contains a list of seller data processors that are offering merchantable work objects 180 associated with the search object 475. For each seller data processor 275, a list of merchantable works is given that matches the merchantable work identifier. The user may then pick a particular merchantable work to discover its merchantable work identifier. For each merchantable work, the merchantable work identifier may include a seller fee, file type, file size and other such information to aid the buyer in deciding from which seller data processor 275 to purchase a digital data file 175 associated with the merchantable work 180.

Next, at step 482, a user chooses a seller data processor 275 from the list of seller data processors 275 included with the search results object 500. The user then contacts the chosen seller data processor 275 to determine if the user can negotiate for a particular digital data file 175. The merchant or seller can then accept or deny the negotiation request 501 through seller data processor 275. If the request 501 is denied at step 484, the user may return to step 482 and choose another seller data processor 275 from those listed in the search results object 500.

Upon acceptance of the negotiation request 501 from the seller through seller data processor 275, the user, through buyer data processor 300, exchanges a proposed transaction contract 525 with seller data processor 275 at step 485. The proposed transaction contract 525 may be generated solely by the buyer, the seller, or may be generated from a transaction contract template 526 provided by verification authority 25 (see FIG. 1). Proposed transaction contract 525 preferably contains a listing of the digital data files 175 to be purchased, an itemized list of costs summing to a total price, and other negotiated values such as an average bandwidth rate agreement. The seller, through the seller data processor 275, may then accept or reject proposed transaction contract 525 as indicated at step 486. If proposed transaction contract 525 is rejected, the user can modify proposed transaction contract 525 at step 487a and repeat step 485 until either party stops responding.

Once proposed transaction contract 525 is accepted and digitally signed by both parties, both buyer data processor 300 and seller data processor 275 upload the resulting agreed upon transaction contract 530 to verification authority 25, as indicated at step 487b. Proposed transaction contract 525 can be digitally signed using a public digital signature tool or through a digital signature module available through verification authority 25. A digital signature validation tool can be used to verify the digital signature. Verification authority 25 stores transaction contract 530 for the duration of the purchase process, preferably in a transaction contract database. At step 488, verification authority 25 notifies both the buyer, through buyer data processor 300, and the seller, through seller data processor 275, that transaction contract 530 has been accepted or rejected by verification authority 25. Verification authority 25 preferably evaluates the contract to verify the parties and to verify that a correct merchantable work identifier is listed. Once verified, transaction contract 530 is a legally binding contract between the buyer and the seller. On the rare occasion that a transaction contract 530 is rejected, buyer data processor 300 and seller data processor 275 are notified as indicated at step 489a, and may resubmit a more compliant transaction contract 530.

At this point, the seller, through seller data processor 275, tags the digital data file 175 being sold with an internal (contained in the file meta-data) or external (as a separate file) digital receipt of sale or watermark as indicated at step 489b. The watermark preferably contains identifying information for the buyer data processor and seller data processor. In this way a buyer has incentive not to re-distribute that particular digital data file 175 via another computer system. The digital data file 175 is watermarked using a public digital signature method such as the Digital Signature Standard (DSA), or is marked using a watermark module 531 provided by verification authority 25 (see FIG. 1). Watermark module 531 can be in the form of a separate user downloadable file, or can be incorporated into each of buyer and seller applications 305 and 306. Watermark module 531 can also remove previous embedded watermarks from a digital data file 175 before transmission of the digital data file 175 to a buyer data processor 300. Once old watermark information is removed from the digital data file 175, new buyer and seller information can be incorporated into the digital data file 175 by embedding a new watermark in the file. When utilized, watermark module 531 automatically embeds a digital data receipt in a digital data file 175 sold using SFDN 10. The digital data file 175 may be processed further by the seller to personalize the data to the buyer (for example: adding digital rights management tags, modifying an internal watermark or image, or processing the digital data in any way as to provide a more personalized digital file for the buyer).

The digital data file 175 is then preferably encrypted using either a standard encryption method (for example: GNU Pretty Good Privacy using RSA or ElGamal encryption methods), or using an encryption/decryption module 532 provided by verification authority 25 (see FIG. 1). Encryption/decryption module 532 provides a way of encrypting a digital data file 175 during transmission of the file from a seller data processor 275 to a buyer data processor 300 and for embedding a decryption key 535 in an associated transaction contract 530 transmitted to verification authority 25 via communications network 15. Regardless of what decryption method is used, a decryption key 535 is sent to verification authority 25 for safe keeping, as indicated at step 489c. The digital data file 175 may optionally not be encrypted, in which case a blank decryption key 535 is uploaded to verification authority 25.

Once the digital data file 175 has been encrypted and a decryption key 535 uploaded, seller data processor 275 notifies buyer data processor 300 that it may download the encrypted digital data file 175 from the seller. Turning now to FIG. 7B, buyer data processor 300 then proceeds to download the encrypted digital data file 175 at step 490 from seller data processor 275. Upon completing the file download, buyer data processor 300 notifies verification authority 25 that it has completed the download at step 491. Verification authority 25 completes the transaction in step 492 by transferring the agreed upon funds in transaction contract 530 to each one of the payee and seller accounts (250, 275) associated with the digital data file 180 sold. Finally, decryption key 535 is downloaded by buyer data processor 300 from verification authority 25 by the user at step 493. The user can then decrypt the purchased digital data file 175 using the downloaded decryption key 535.

The users of SFDN 10 are not anonymous, and as previously mentioned, are preferably provided with trustworthiness ratings 212 by verification authority 25. Rating 212 can be developed using any number of trustworthiness indicators. For example, in the preferred embodiment buyer application 305 can recognize the presence or absence of a watermark. If a proper watermark is not included with a digital data file 175, buyer application 305 reports the seller who sold the digital data file 175 to verification authority 25, and the seller's rating 212 is lowered. Likewise seller application 306 can recognize improper behavior by a buyer. If no improper behavior is identified during the course of a transaction using SFDN 10, the positive transaction will be incorporated into the users' respective rating 212. This process of rating users is indicated in FIG. 7B in step 494.

It should be understood that once a user buys a particular digital data file 175, the user may then become a seller of that digital data file 175 using SFDN 10. To become a seller, a user simply registers with SFDN 10 as a seller as outlined above. In this way, the SFDN 10 allows a user to be both a buyer and a seller of digital data files 175 while maintaining the appropriate copyright royalty payments and funds disbursements.

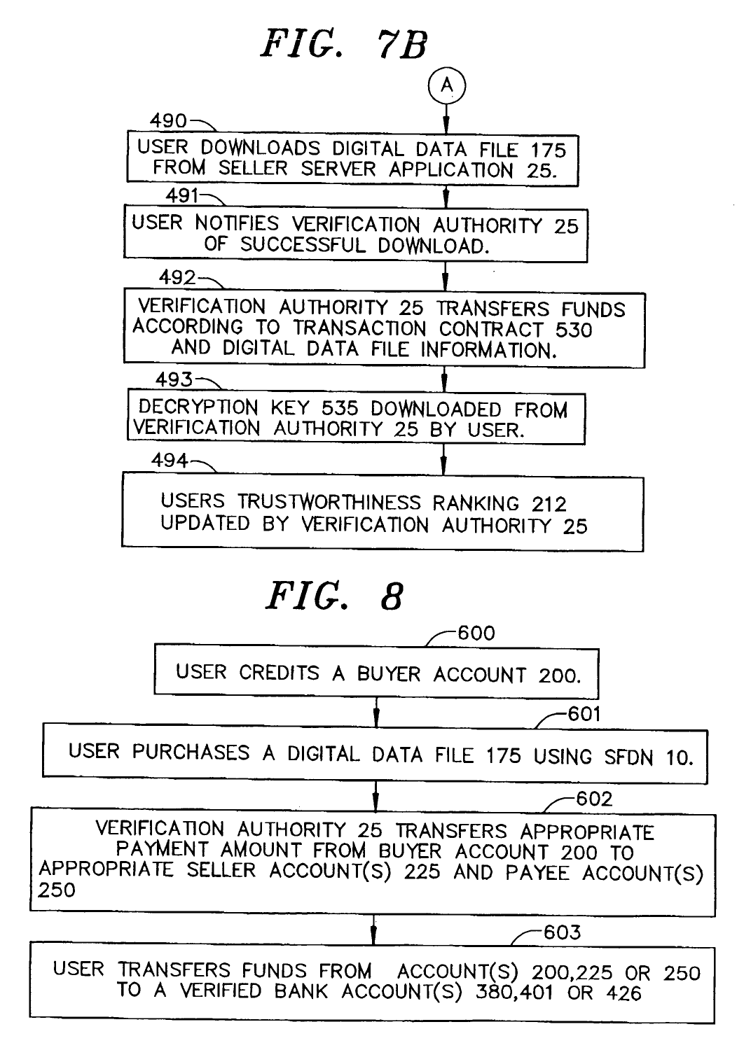

Turning now to FIG. 8 there is depicted a financial-level view of the flow of funds through the SFDN 10 system. All funds in the SFDN 10 originates from the plurality of buyer accounts 200 and eventually is transferred to payee and seller accounts 250 and 225. A user in the system may have one or more buyer and seller accounts 200 and 225 as well, in which case funds may be transferred between the various accounts. When a user wishes to make a purchase, the user contacts verification authority 25 and credits their buyer account 200 using a credit card, debit card or other funds transfer method, as indicated at step 600. Verification authority 25 processes the charge transaction and credits buyer account 200 with the appropriate amount of funds.

The user may then purchase a desired digital data file 175 using SFDN 10 as indicated by step 601 (see the purchase process in FIGS. 7a and 7b). As shown in step 602, once the purchase has occurred, the appropriate payment can be subtracted from the user's buyer account 200 and can be appropriately divided between the seller account 225 and each payee account 250 that should receive payment for the digital data file 175 sold. There can be multiple payees for each digital data file 175. As previously discussed, details of the transaction fees are encapsulated in the transaction contract 530, which is affected by information contained in merchantable work object 175 in verification authority 25.

Funds may accrue in a payee account 250 until the payee decides to transfer it to a verified bank account 401. Likewise, a user may transfer funds from one or more seller or buyer accounts 200, 225 to one or more verified bank accounts 380, 401 or 426. This transfer of funds from an account established in verification authority 25 to a separate verified bank account 380, 401 or 426, is indicated at step 603.

Although others have created digital file sales mechanisms, also known as e-commerce applications, peer-to-peer file sharing networks, micro-payment applications and variations and combinations of the previously mentioned systems, the SFDN 10 of the present invention is considered to be advantageous for a number of reasons as follows:
The system solves a very serious problem in the digital content creation and sales industries; namely the sale, distribution and royalty disbursement of purely digital, copyrighted media.
The system is based on consumer and seller trust and reputation; users are not anonymous on the system and thus have a strong obligation to not pirate material.
The core of the system is very flexible and does not depend on digital rights management technology and allows both the buyers and sellers to choose the most favorable media format.
Buyers can be sellers as well without needing a special license for any of the material on the network, which also gives them a financial incentive to become part of the digital media distribution process.
The system allows copyright owners to have full control over how their works can be distributed, who can distribute them, as well as each merchantable royalty scheme.
The system protects consumers fair use rights while providing the maximum financial and distribution benefit for creators.
The system allows each buyer and seller data processor of the system to be created by an independent party. The system may also protect users from untrustworthy buyers and sellers by providing a rating for each buyer and seller in the system.
There is a central, trusted authority that is responsible for all financial transactions while the distribution mechanism for the set of merchantable works is distributed and quite dynamic, thus security of financial transactions are ensured while providing the maximum possible distribution bandwidth.

Although described with reference to a preferred embodiment of the invention, it should be readily understood that various changes and/or modification can be made to the invention without departing from the spirit thereof. While this description concerns a detailed, complete system, it employs many inventive concepts, each of which is believed patentable apart from the system as a whole. The use of sequential numbering to distinguish the methods employed is used for descriptive purposes only, and is not meant to imply that a user must proceed from one step to another in a serial or linear manner. In general, the invention is only intended to be limited by the scope of the following claims.

1. A computing system for secure sales transactions of digital data files on a communications network comprising:
a database including a merchantable work object, the merchantable work object being associated with a digital data file available for purchase;
a buyer account;
a seller account;
a payee account; and
a verification authority connected to said communications network, the verification authority being adapted to store a transaction contract negotiated by a buyer and a seller, the verification authority further being adapted to distribute appropriate funds from said buyer account into the seller account and the payee account according to payment information included with the merchantable work object upon purchase of the digital data file by a buyer through the computing system.

2. The computing system of claim 1, wherein the verification authority includes a transaction contract template downloadable by a user of the computing system.

3. The computing system of claim 1, wherein the verification authority includes a watermark module downloadable by a user of the computing system.

4. The computing system of claim 1, further comprising: a search database having searchable digital data file information.

5. The computing system of claim 1, wherein the database, buyer account, seller account and payee account are part of the verification authority.

6. The computing system of claim 1, further comprising:
a seller database connected to the communications network;
a buyer database connected to the communications network; and
a payee database connected to the communications network.

7. The computing system of claim 1, further comprising: an encryption/decryption module downloadable by a user of the computer system.

8. A method for utilizing a computer system for the secure buying and selling of digital data files over a communications network, the method comprising:
receiving a search object from a buyer, the search object including information associated with a digital data file;
utilizing a search database to generate a search results object based on said search object;
sending said search results object to said buyer, the search results object including contact information for a seller;
receiving a transaction contract from said buyer and seller, the transaction contract including information associated with the digital data file; and
transferring funds from a buyer account associated with said buyer to a seller account associated with said seller based on the transaction contract upon notification by the buyer of a proper transfer of the digital data file from the seller to the buyer.

9. The method of claim 8, further comprising:
creating a payee account based on payee information, the payee account being associated with the digital data file; and
transferring funds from a buyer account associated with said buyer to the payee account associated with the digital data file.

10. The method of claim 8, further comprising: verifying at least one of the buyer account information, the seller account information and the payee account information.

11. The method of claim 8, further comprising: providing a transaction contract template to a user of the computer system.

12. The method of claim 8, further comprising: verifying the transaction contract information.

13. The method of claim 8, further comprising: employing an encryption/decryption module to the users of the computer system.

14. The method of claim 8, further comprising: uploading a decryption key from the seller and transferring the decryption key to the buyer upon notification by the buyer of a proper transfer of the digital data file from the seller to the buyer.

15. The method of claim 8, further comprising: receiving bank account information from a user of the computing system and verifying the bank account information to provide the user with a verified bank account.

16. The method of claim 15, further comprising: transferring funds from a user's payee account, buyer account, or seller account to said user's verified bank account upon request by the user.

17. The method of claim 8, further comprising: providing a watermark module to the seller, the watermark module adapted to digitally mark the digital data file before purchase by the buyer.

18. The method of claim 8, further comprising: updating the seller's trustworthiness ranking based on a purchase transaction.

19. The method of claim 8, further comprising:
creating a buyer account based on buyer information; and
creating a seller account based on seller information.
